(19) United States
(12) Patent Application Publication
(10) Pub. No.: US 2014/0136965 A1
(43) Pub. Date: May 15, 2014

(54) SYSTEM FOR COMPOSING DOCUMENT USING IMAGE AND METHOD FOR COMPOSING DOCUMENT

(71) Applicant: Young Wan Byun, Suwon-si (KR)

(72) Inventor: Young Wan Byun, Suwon-si (KR)

(21) Appl. No.: 14/129,065

(22) PCT Filed: Jun. 25, 2012
(86) PCT No.: PCT/KR2012/005005

§ 371 Date: Dec. 23, 2013

(30) Foreign Application Priority Data
Jun. 23, 2011 (KR) 10-2011-0061100

(51) Int. Cl. G06F 17/24

(52) U.S. Cl. CPC G06F 17/24
USPC 715/255

(57) ABSTRACT

A system for composing a document using an image and a method for composing the document comprises: a document composition portion for executing a document composition program so that a user compose the document; and a document screen dividing portion for dividing a document composition screen into a first divided screen and a second divided screen, when a request for inserting a predetermined image data through an input portion is received while composing the document by means of the document composition portion, wherein the document can be composed in the first divided screen, and image data to be inserted can be edited on the second divided screen.

### BACKGROUND

The present invention relates to a system for composing a document, and in particular to a system for composing a document using an image and a method for composing a document which have features in that when a user inputs a request for inserting an image data (for example, a PDF data, a JPG data, etc.) into a certain document that a user is working on (for example, a Word document, a Power Point document, an Excel document, a HWP document, etc.), a document composition screen is so divided that a document can be composed on one screen, and an image data to be inserted into the document can be edited on the other screen, by means of which the user can easily compose all kinds of documentation works (for example, a document composition work, a correction of an image to be inserted into a document, a saving work, etc.) at a time on one screen.

The present invention is directed to a system for composing a document using an image and a method for composing the document.

In recent years, when it needs to convert an information shown on a paper into a digital form, a user scans a corresponding paper document and converts the data of a generated document into an image file such as JPEG, PS, PDF, TIFF, etc. and saves in a storage medium.

The thusly generated image data is inserted into a document which is being composed (for example, a Word document, a HWP document, a Power Point document, an Excel document, etc.). Hereinafter, the work that an image data is inserted into a precast document will be described.

In the conventional art, when it needs to insert a certain image data into a document in the middle of documentation, the image data should be stored in a certain memory (for example, a memory of a computer which is in process, and a storage medium such as a USB.

In this state, a user uploads a corresponding image data which is stored in the memory in the middle of documentation and inserts into the document.

If the image data is not stored in the memory, a certain work should be previously conducted, in which work the user scans using a scanner and generates an image data and saves into a memory.

When it needs to edit the image data, the document composition work is performed after the image data is edited with a certain image editing program (for example, Photo Shop program, Illustrator program, etc.) and is saved into the memory.

In the conventional art, when it needs to insert into a document a certain image data that a user wants, the following processes should be previously conducted: a user scans a certain document using a scanner and generates in a form of an image data and saves into a memory, and then edits the image data using an image editing program and stores the edited image data.

Afterward, the user can upload an image data saved in the memory in the middle of composing the document using a document composition program and can insert the edited image data into the document which is in process.

In the conventional art, when it needs to insert an image data into a document which is process, a complicated previous work procedure (the image which was made through the complicated works using a certain device (for example, an image generation device (a scanner, a camera, etc.) is saved into a user's PC and then is uploaded and edited and resaved) should be conducted.

The image is edited and saved on the executed image editing program, and the saved image data can be inserted into the document. For this process, the image editing program is necessary, and the user should be skilled with each of the image editing programs in order to insert a desired image into the document which is in process.

### SUMMARY OF INVENTION

Accordingly, the present invention is made so as to improve the above mentioned problems. It is an object of the present invention to provide a system for composing a document, and in particular to a system for composing a document using an image and a method for composing a document which have features in that when a user input a request for inserting an image data (for example, a PDF data, a JPG data, etc.) into a certain document that a user is working on (for example, a Word document, a Power Point document, an Excel document, a HWP document, etc.), a document composition screen is so divided that a document can be composed on one screen, and an image data to be inserted into the document can be edited on the other screen, by means of which the user can easily compose all kinds of works (for example, a document composition work, a correction of an image to be inserted into a document, a saving work, etc.) at a time on one screen.

It is another object of the present invention to provide a system for composing a document using an image and a method for composing the document which has features in that when a user inputs a request for inserting a scanned file into a document in the middle of documentation, an image data is generated using a scanning unit, and the image data is automatically inserted into a certain portion of a document in a form that a user has designated, so the user can easily compose documents.

To achieve the above objects, there is provided a system for composing a document using an image, comprising a document composition unit which allows a user to execute a document composition program and to compose a document; and a document screen dividing unit which divides a document composition screen into a first dividing screen and a second dividing screen when a request for inserting a certain image data from an input unit in the middle of documentation on the document composition unit, and allows the document to be composed on the first dividing screen and allows an image data, which will be inserted, to be edited on the second dividing screen.

At this time, the document composing system comprises a scanning unit which generates an image data through its scanning operations.

Meanwhile, the document dividing unit inquires whether an image data to be inserted into a document which is in process is an image data which is stored in a storing unit or an image data which should be obtained from a scanning unit, and as a result of the inquiry, if the image data is stored in the storing unit, it is processed that the image data is directly outputted on the second dividing screen and if the image data should be obtained from the scanning unit, the scanning unit is activated, and an image data is generated, and the image data is outputted on the second dividing screen

In addition, the document composing system comprises an editing tool provision unit which provides an editing tool at one side of the second dividing screen when the image data is outputted on the second dividing screen, with which image tool the arranged position of the image data or the image data can be edited.

At this time, the editing tool provision unit judges the type of the document which is in process, and provides an editing tool which is proper to the judged type of the document.

The editing tool provision unit provides a first editing tool when the type of the document which is in process, is a structure formed of rows and columns.

At this time, the first editing tool comprises a zone setting unit for setting a certain zone of the image data; a cutting-off unit for cutting off a certain zone of the image data; a rotation editing unit for rotating the direction of the image data; a size adjusting unit for adjusting the size of the image data; a color sense adjusting unit for adjusting the color senses of the image data; a brightness adjusting unit for adjusting the brightness of the image data; a text insertion unit for inserting texts into the image data; a zooming unit for zooming in or out the image data; a printer unit for printing out the image data; a background process unit for setting the image as a background of the document which is in process; a size adjusting unit for changing the size of the image data based on the widths of the columns of the document; and a returning unit for returning the routine to the previous editing step when the image data is edited.

In addition, the document composing system comprises an insertion process unit for allowing the image data edited with the editing tool to be inserted into a certain zone of the document that the user has designated; and a storing process unit for allowing the image data edited with the editing tool to be inserted into the storing unit.

Meanwhile, the editing tool provision unit provides a second editing tool when the types of the document which is in process, is formed of multiple cells.

The second editing tool comprises a zone setting unit for setting a certain zone of the image data; a cutting-off unit for cutting off a certain zone of the image data; a rotation editing unit for rotating the direction of the image data; a size adjusting unit for adjusting the size of the image data; a color sense adjusting unit for adjusting the color senses of the image data; a brightness adjusting unit for adjusting the brightness of the image data; a text insertion unit for inserting texts into the image data; a zooming unit for zooming in or out the image data; a printer unit for printing out the image data; a background process unit for setting the image as a background of the document which is in process; a first insertion unit for allowing the image data to be inserted in an original size into a certain cell that a user has designated; a second insertion unit for adjusting the size of the image data in proportion to the horizontal and vertical lengths of a certain cell that the user has designated and for inserting the size-adjusted image data into the certain cell; and a returning unit for returning to the previous editing step when the image data is edited.

To achieve the above objects, there is provided a method for composing a document in a system for composing a document using an image, comprising a step A in which a request for inserting a certain image data is received from an input unit in the middle of documentation of a document as a document composing system executes a document composition program; a step B in which the document composing system divides a document composition screen into a first dividing screen and a second dividing screen and allows a document to be composed on the first dividing screen, and allows an image data, which will be inserted, to be edited on the second dividing screen; and a step C in which when the document composing is finished, the document composing system stores the composed document.

The step B comprises a step B1 in which the document composing system divides a document composition screen into a first dividing screen and a second dividing screen; a step B2 in which the document composing system inquiries whether an image data to be inserted into a document which is in process, is an image data stored in a storing unit or an image data which should be obtained from a scanning unit; a step B3 in which as a result of the inquiry, if the image data is stored in the storing unit, it is processed that the image data is directly outputted on the second dividing screen and if the image data should be obtained from the scanning unit, the scanning unit connected to the document composing system is activated, and an image data is generated, and the image data is outputted on the second dividing screen; and a step B4 in which the document composing system allows a document to be composed on the first dividing screen, and allows the image data outputted in the step B3 to be edited on the second dividing screen.

Meanwhile, in the step B4 is provided an editing tool at one side of the second dividing screen when the image data is outputted on the second dividing screen for editing the arranged position of the image data or the image data.

In addition, in the step B4 is provided an editing tool for judging the type of the document which is in process, when an image data is outputted on the second dividing screen, the editing tool corresponding to the type of the document.

The present invention has advantageous features in that when a user input a request for inserting an image data (for example, a PDF data, a JPG data, etc.) into a certain document that a user is working on (for example, a Word document, a Power Point document, an Excel document, a HWP document, etc.), a document composition screen is so divided that a document can be composed on one screen, and an image data to be inserted into the document can be edited on the other screen, by means of which the user can easily compose all kinds of documentation works (for example, a document composition work, a correction of an image to be inserted into a document, a saving work, etc.) at a time on one screen.

In addition, the present invention has advantages in the points that when a user inputs a request for inserting a scanned file into a document in the middle of documentation, an image data is generated using a scanning unit, and the image data is automatically inserted into a certain portion of a document in a form that a user has designated, so the user can easily compose documents.

### BRIEF DESCRIPTION OF DRAWINGS

FIG. 1 is a block diagram illustrating an internal construction of a system for composing a document using an image according to a preferred embodiment of the present invention.

FIG. 2 is a flow chart of an operation procedure of a system for composing a document using an image according to a preferred embodiment of the present invention.

FIGS. 3 to 6 are views for describing an operation that a system for composing a document using an image provides a first editing tool according to the present invention.

FIGS. 7 to 8 are views for describing an operation that a system for composing a document using an image provides a second editing tool according to the present invention.

### DETAILED DESCRIPTION OF THE INVENTION

The system for composing a document using an image according to the present invention will be described with reference to the accompanying drawings.

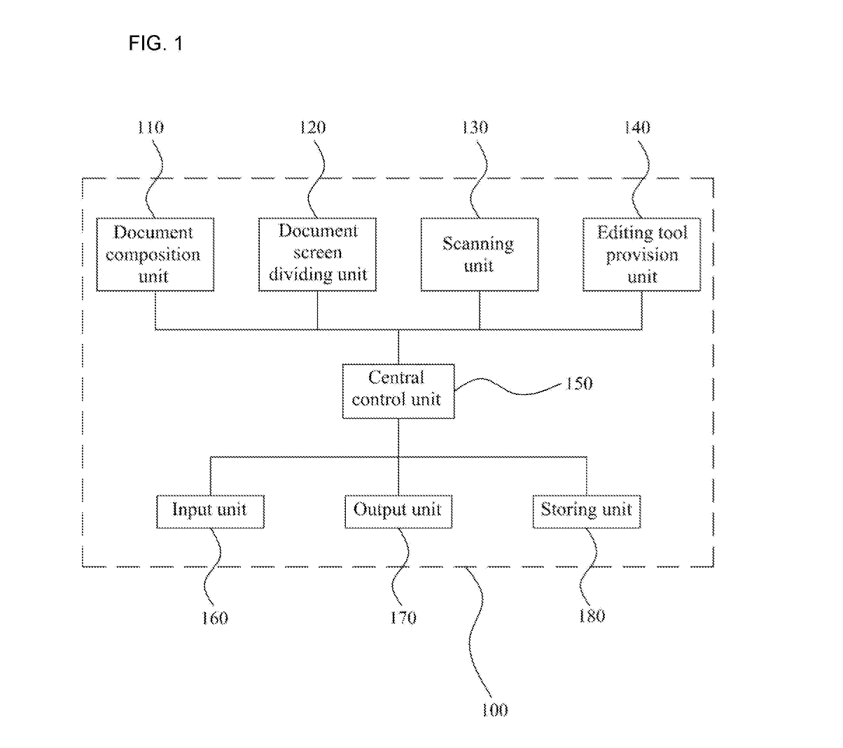

FIG. 1 is a block diagram illustrating an internal construction of a system for composing a document using an image according to a preferred embodiment of the present invention.

As shown in FIG. 1, a document composing system 100 equipped with a scanning function according to the present invention comprises a document composition unit 110, a document screen dividing unit 120, a scanning unit 130, an editing tool provision unit 140, a central control unit 150, an input unit 160, an output unit 170, a storing unit 180, an insertion process unit (not shown) and a storing process unit (not shown).

The document composition unit 110 allows a user to execute a document composition program and to generate a document in a certain form (for example, a Word document, a Power Point document, an Excel document, etc.).

When a user inputs a request for inserting a certain image data into a document, which is in process, through an input unit 160 while the user is generating a document on a document composition unit 110, the document screen diving unit 120 divides the document composition screen 200 into a first dividing screen 210 and a second dividing screen 220 of which on the first dividing screen 210 is processed a document, and on the second dividing screen 220 is edited an image data which is to be inserted.

More specifically, the document screen dividing unit 120 inquires whether the image data to be inserted into a document which is in process is an image data which is stored in a storing unit 180 or an image data which should be obtained from a scanning unit 130. As a result of the inquiry, if the image data is stored in the storing unit 180, it is processed that the image data is directly outputted on the second dividing screen 220 and if the image data should be obtained from the scanning unit 130, the scanning unit 130 is activated, and an image data is generated, and the image data is outputted on the second dividing screen 220.

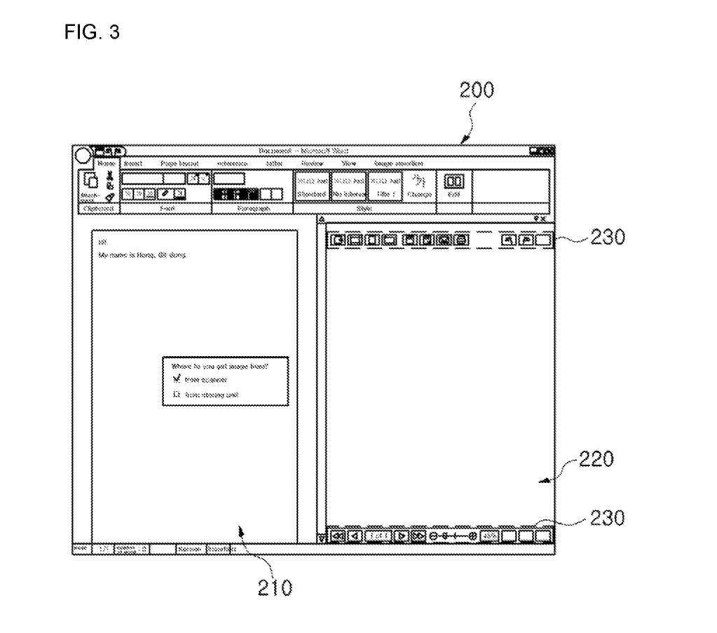

FIG. 3 is a view for describing an operation of the document screen dividing unit. When the user wants to obtain an image data using a scanner, the document screen dividing unit enables a scanning work to be processed by way of the scanning unit 130, and enables a preview image of the image data to be outputted on the second dividing screen 220 so as to check out the proceeding state of the scanning work. At this time, the preview image is sized at a certain aspect ratio to visually check out a schematic shape of the image data scanned by means of the scanning unit 130. When a preview image authorization signal is received, the image data generated through the scanning work is outputted on the second dividing screen 220.

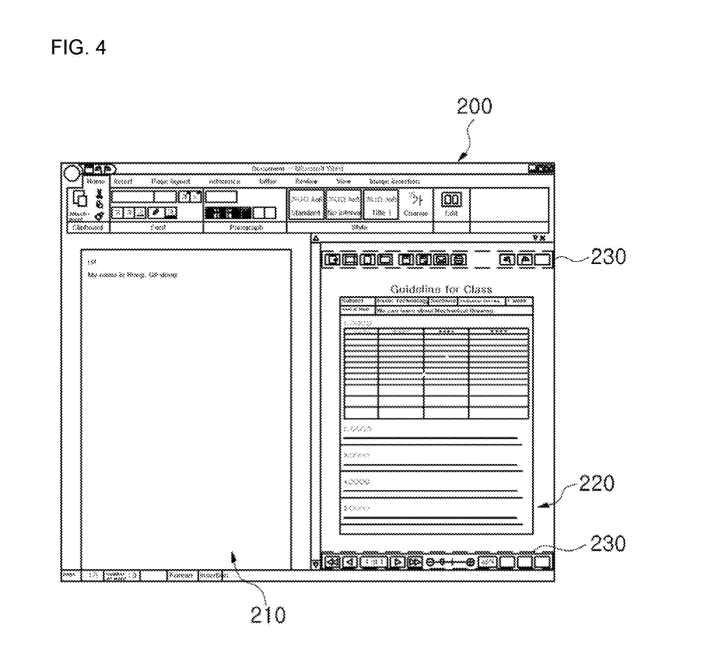

FIG. 4 is a view illustrating a state that an image data is outputted on the second dividing screen after the scan is finished. The present invention makes it possible to insert a certain image into the document which is in process unless the user does a certain work even when the image data is not stored in the storing unit 180.

The scanning unit 130 performs a scanning work and generates an image data. More specifically, when a user arranges a file (for example, a document, a photo, etc.) to be scanned, on a file rest portion and inputs a scanning command, the document is judged by a judging means such as a CCD (Charge Coupled Device), and a certain image data is generated based on the judged contents. At this time, the image data can be saved in various formats such as pdf, bmp, jpg, tiff, etc.

On one side of the second dividing screen 220, the editing tool provision unit 140 is equipped with an editing tool 230 which helps edit a position of an image data or an image data when the image data is outputted on the second dividing screen 220.

At this time, it is preferred that the editing tool provision unit 140 judges the type of a document which is in process (for example, a Word type, an Excel type, a Power Point type, etc.), and provides a certain editing tool 230 which is proper to the judged type of the document.

If the type of the document which is in process is a structure of rows and columns (for example, a Word type, a HWP type, a Power Point type, etc.), a first editing tool is provided. FIGS. 3 to 6 are views illustrating the first editing tool.

As shown therein, the first editing tool comprises a zone setting unit for setting a certain zone of the image data; a cutting-off unit for cutting off a certain zone of the image data; a rotation editing unit for rotating the direction of the image data; a size adjusting unit for adjusting the size of the image data; a color sense adjusting unit for adjusting the color senses of the image data; a brightness adjusting unit for adjusting the brightness of the image data; a text insertion unit for inserting texts into the image data; a zooming unit for zooming in or out the image data; a printer unit for printing out the image data; a background process unit for setting the image as a background of the document which is in process; a size adjusting unit for changing the size of the image data based on the widths of the columns of the document; and a returning unit for returning the routine to the previous editing step when the image data is edited.

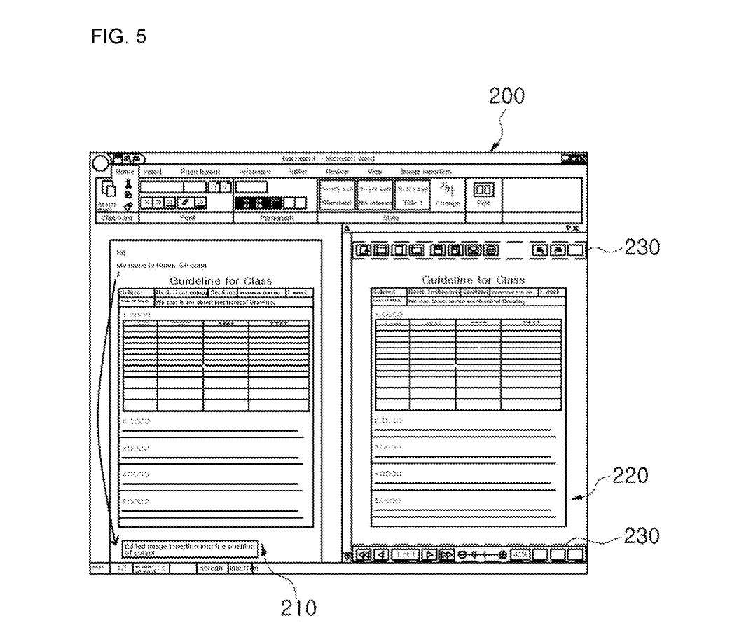

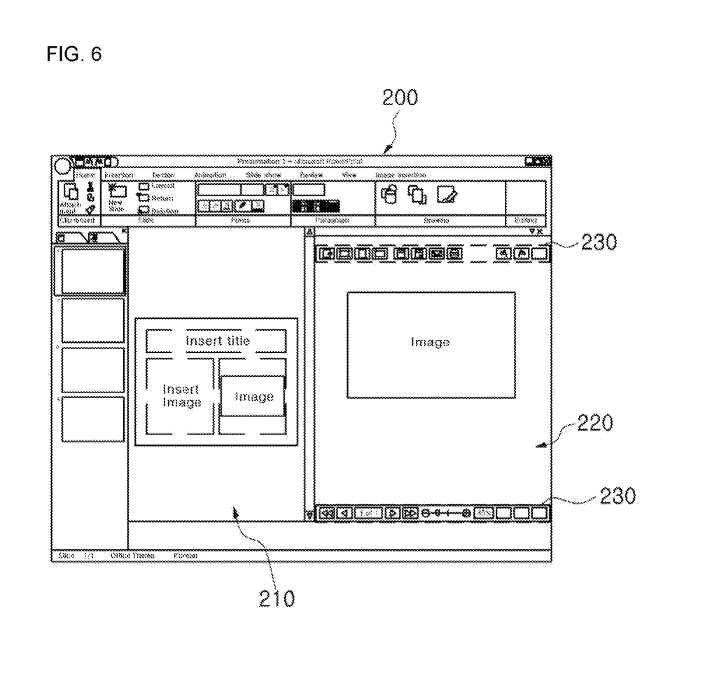

FIG. 5 is a view illustrating a state that an image data is inserted into a portion where a user wants to, and FIG. 6 is a view illustrating a state that an edited image data is inserted into an image box of a slide of a power point document. At this time, the image data can be inserted into the picture box, but in case of a text box, the image data cannot be inserted. When a request for inserting an image data into a text box, an error message informing that an image data cannot be inserted is produced on a window.

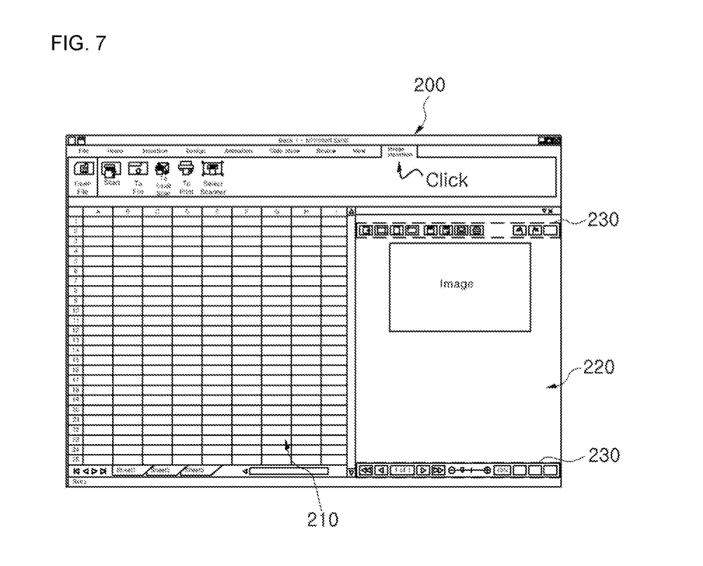

The editing tool provision unit 140 is equipped with a second editing tool when the type of the document which is in process is formed of multiple cells (for example, it is formed in an Excel type). FIGS. 7 to 9 are views illustrating a construction that the editing tool provision unit is formed of a second editing tool.

At this time, the second editing tool comprises a zone setting unit for setting a certain zone of the image data; a cutting-off unit for cutting off a certain zone of the image data; a rotation editing unit for rotating the direction of the image data; a size adjusting unit for adjusting the size of the image data; a color sense adjusting unit for adjusting the color senses of the image data; a brightness adjusting unit for adjusting the brightness of the image data; a text insertion unit for inserting texts into the image data; a zooming unit for zooming in or out the image data; a printer unit for printing out the image data; a background process unit for setting the image as a background of the document which is in process; a first insertion unit for allowing the image data to be inserted in an original size into a certain cell that a user has designated; a second insertion unit for adjusting the size of the image data in proportion to the horizontal and vertical lengths of a certain cell that the user has designated and for inserting the size-adjusted image data into the certain cell; and a returning unit for returning to the previous editing step when the image data is edited.

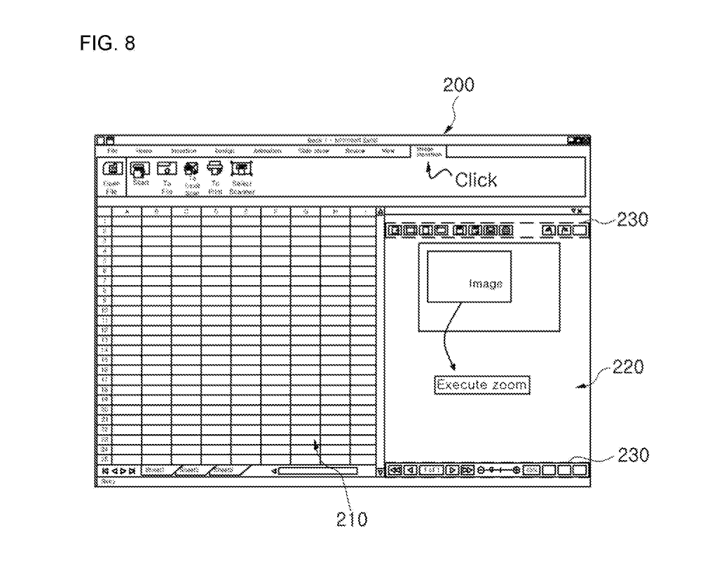

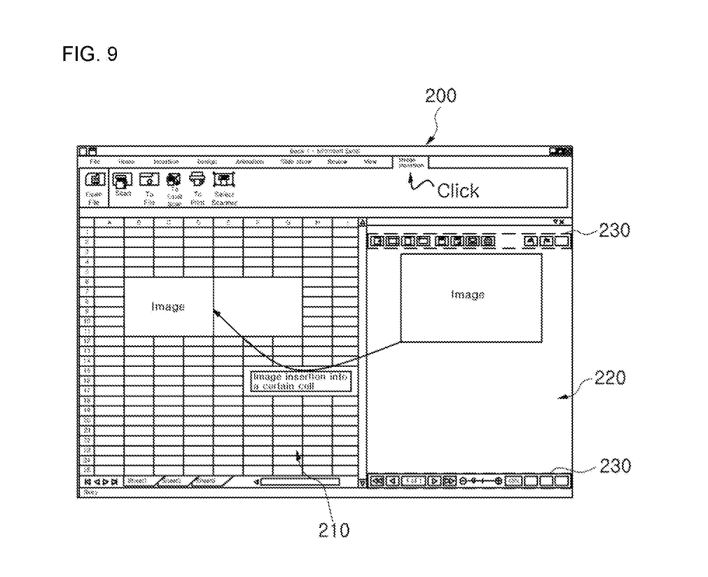

FIG. 8 is a view illustrating a state that using a zone setting unit, a user sets a certain portion of an image data as a zone. The set zone can be cancelled by a zone setting cancellation unit.

FIG. 9 is a view illustrating a state that with the aid of a second insertion unit, an image size is reduced in proportion to the size of a certain cell, and the size-reduced image is inserted into the certain cell. The image can be inserted into the cell that the user has designated. In this case, when the size of the cell is changed, it is preferred that the size of the image is also changed. This feature is advantageous when it needs to change the size of the image based on the size of the cell without setting each time the property of the image data.

The user can edit the image data using the editing tool 230. At this time, the editing tool provision unit 140 allows the image data to be edited in accordance with an editing control signal inputted by the editing tool 230.

The insertion process unit (not shown) allows the image data edited by the editing tool 230 to be inserted into a certain zone of the document that the user has designated. FIG. 5 is a view illustrating an operation that a certain image file is inserted into the document of a Word type. The edited image can be inserted into the position of the cursor.

The storing process unit (not shown) allows the image data edited by the editing tool 230 to be automatically inserted into the storing unit 180. It is preferred that the image data is named based on a user's request.

The central control unit 150 controls the whole processes on the output screen in the form of documents on which output screen the user composes documents and edits the images, etc.

The input unit 160 receives a user's request. The input unit 160 is equipped with icons and buttons which are set for various operations and menu setting so as to perform the above described functions. The input unit 160 comprises an input device formed of a keypad, etc. or a general display device such as a LCD, etc. As the electronic instrument is made compact-sized, there may be provided a touch panel which is capable of concurrently performing input and display functions.

The output unit 170 is generally formed of a LCD (Liquid Crystal Display).

The storing unit 180 is configured to store the image data edited with the editing tool 230 and documents. At this time, it is preferred that the image data and documents are table-formatted by dates. The storing unit 80 may be formed of various storages such as EPROM, flash memory, external memory, etc. based on the capacity of the data to be stored.

The operations of the system for composing a document using an image according to the present invention will be described with reference to the accompanying drawings.

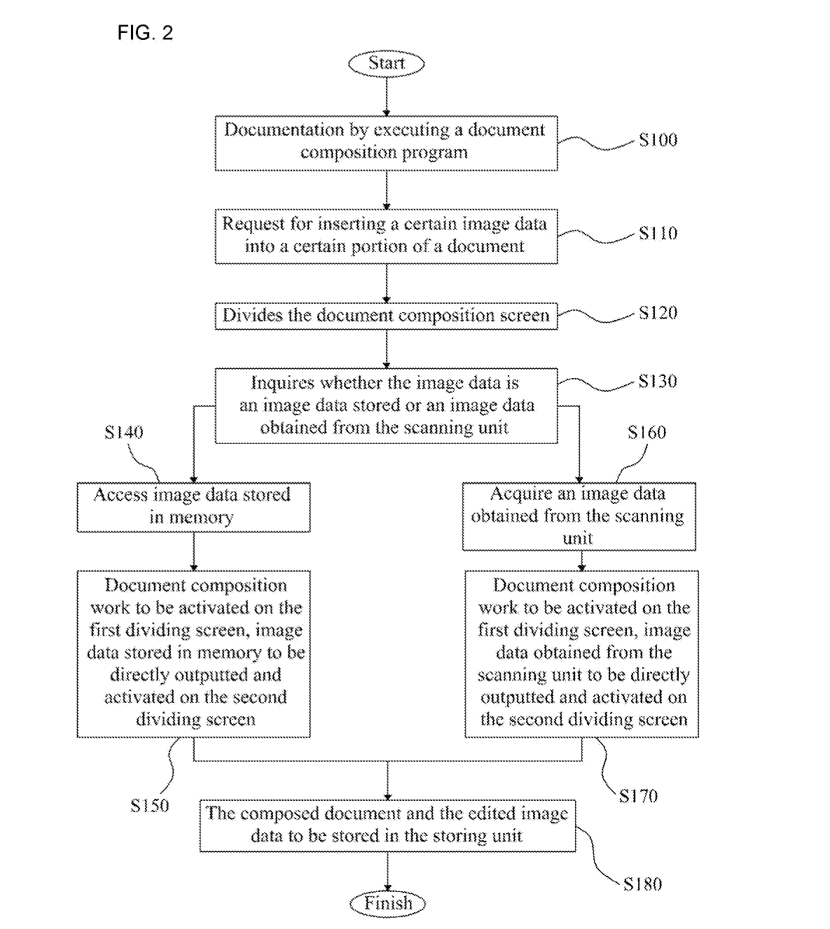

FIG. 2 is a flow chart of an operation procedure of a system for composing a document using an image according to a preferred embodiment of the present invention.

First of all, the document composing system 100 may receive a request for inserting a certain image data into a certain portion of a document which is in process, through an input unit 160 (S110) in the middle of documentation (S100) by executing a document composition program.

Afterward, the document composing system 100 divides the document composition screen 200 into a first dividing screen 210 and a second dividing screen 220 (S120).

The document composing system 100 inquires whether the image data which is to be inserted into the document which is in process, is an image data stored in the storing unit 180 or an image data which should be obtained from the scanning unit 130 (S130).

As a result of the inquiry of S130, if the image data is stored in the storing unit 180, the document composing system 100 allows the image data to be directly outputted on the second dividing screen 220 (S150).

When it needs to obtain an image data using the scanning unit 130 as a result of the inquiry of S130, the document composing system 10 activates the scanning unit 130 connected to the document composing system 100 and generates an image data and outputs the image on the second dividing screen 220 (S170). At this time, it is preferred that the preview image is generated into an image data after the user authorizes the preview image.

The document composing system 100 allows the document composition work to be activated on the first dividing screen 210 and allows the image data from the output unit 170 to be activated on the second dividing screen.

At this time, the document composing system 100 provides an editing tool 230 at one side of the second dividing screen 220 for the arranged position of the image data or the image data to be edited. Here, the user can easily edit the image data using the editing tool 230.

It is preferred that when the image data is outputted on the second dividing screen 220, the document composing system 100 judges the type of the document which is in process, and the editing tool 240 proper to the type of the document is provided. More specifically, it is judged whether the document is made in the form of Word or Excel, and then the editing tool 230 proper to the judged type of the program is provided.

When a completion signal indicating that the document composing is finished is received from the user as the user inputs using the input unit 160, the document composing system 100 allows the composed document and the edited image data to be stored in the storing unit 180 (S180). At this time, the document composing system 100 can receive from the input unit 160 the names of the documents and the edited image data.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A system for composing a document using an image, comprising:
a document composition unit which allows a user to execute a document composition program and to compose a document; and
a document screen dividing unit which divides a document composition screen into a first dividing screen and a second dividing screen when a request for inserting a certain image data from an input unit in the middle of documentation on the document composition unit, and allows the document to be composed on the first dividing screen and allows an image data, which will be inserted, to be edited on the second dividing screen.

2. The system of claim 1, wherein the document composing system comprises a scanning unit which generates an image data through its scanning operations.

3. The system of claim 2, wherein the document dividing unit inquires whether an image data to be inserted into a document which is in process is an image data which is stored in a storing unit or an image data which should be obtained from a scanning unit, and as a result of the inquiry, if the image data is stored in the storing unit, it is processed that the image data is directly outputted on the second dividing screen and if the image data should be obtained from the scanning unit, the scanning unit is activated, and an image data is generated, and the image data is outputted on the second dividing screen

4. The system of claim 3, wherein the document composing system comprises an editing tool provision unit which provides an editing tool at one side of the second dividing screen when the image data is outputted on the second dividing screen, with which image tool the arranged position of the image data or the image data can be edited.

5. The system of claim 4, wherein the editing tool provision unit judges the type of the document which is in process, and provides an editing tool which is proper to the judged type of the document.

6. The system of claim 5, wherein the editing tool provision unit provides a first editing tool when the type of the document which is in process, is a structure formed of rows and columns, and the first editing tool, comprising:
a zone setting unit for setting a certain zone of the image data;
a cutting-off unit for cutting off a certain zone of the image data;
a rotation editing unit for rotating the direction of the image data;
a size adjusting unit for adjusting the size of the image data;
a color sense adjusting unit for adjusting the color senses of the image data;
a brightness adjusting unit for adjusting the brightness of the image data;
a text insertion unit for inserting texts into the image data;
a zooming unit for zooming in or out the image data;
a printer unit for printing out the image data;
a background process unit for setting the image as a background of the document which is in process;
a size adjusting unit for changing the size of the image data based on the widths of the columns of the document; and
a returning unit for returning the routine to the previous editing step when the image data is edited.

7. The system of claim 6, wherein the document composing system comprises:
an insertion process unit for allowing the image data edited with the editing tool to be inserted into a certain zone of the document that the user has designated; and
a storing process unit for allowing the image data edited with the editing tool to be inserted into the storing unit.

8. The system of claim 5, wherein the editing tool provision unit provides a second editing tool when the types of the document which is in process, is formed of multiple cells, and the second editing tool, comprising:
a zone setting unit for setting a certain zone of the image data;
a cutting-off unit for cutting off a certain zone of the image data;
a rotation editing unit for rotating the direction of the image data;
a size adjusting unit for adjusting the size of the image data;
a color sense adjusting unit for adjusting the color senses of the image data;
a brightness adjusting unit for adjusting the brightness of the image data;
a text insertion unit for inserting texts into the image data;
a zooming unit for zooming in or out the image data;
a printer unit for printing out the image data;
a background process unit for setting the image as a background of the document which is in process;
a first insertion unit for allowing the image data to be inserted in an original size into a certain cell that a user has designated;
a second insertion unit for adjusting the size of the image data in proportion to the horizontal and vertical lengths of a certain cell that the user has designated and for inserting the size-adjusted image data into the certain cell; and
a returning unit for returning to the previous editing step when the image data is edited.

9. A method for composing a document in a system for composing a document using an image, comprising:
a step A in which a request for inserting a certain image data is received from an input unit in the middle of documentation of a document as a document composing system executes a document composition program;
a step B in which the document composing system divides a document composition screen into a first dividing screen and a second dividing screen and allows a document to be composed on the first dividing screen, and allows an image data, which will be inserted, to be edited on the second dividing screen; and
a step C in which when the document composing is finished, the document composing system stores the composed document.

10. The method of claim 9, wherein the step B comprises:
a step B1 in which the document composing system divides a document composition screen into a first dividing screen and a second dividing screen;
a step B2 in which the document composing system inquiries whether an image data to be inserted into a document which is in process, is an image data stored in a storing unit or an image data which should be obtained from a scanning unit;
a step B3 in which as a result of the inquiry, if the image data is stored in the storing unit, it is processed that the image data is directly outputted on the second dividing screen and if the image data should be obtained from the scanning unit, the scanning unit connected to the document composing system is activated, and an image data is generated, and the image data is outputted on the second dividing screen; and
a step B4 in which the document composing system allows a document to be composed on the first dividing screen, and allows the image data outputted in the step B3 to be edited on the second dividing screen.

11. The method of claim 10, wherein in the step B4 is provided an editing tool at one side of the second dividing screen when the image data is outputted on the second dividing screen for editing the arranged position of the image data or the image data.

12. The method of claim 11, wherein in the step B4 is provided an editing tool for judging the type of the document which is in process, when an image data is outputted on the second dividing screen, the editing tool corresponding to the type of the document.
